(19) United States
(12) Patent Application Publication
(10) Pub. No.: US 2022/0212691 A1
(43) Pub. Date: Jul. 7, 2022

(54) SYSTEMS AND METHODS FOR PROVIDING HAPTIC FEEDBACK TO DRIVERS WHEN ALIGNING ELECTRIFIED VEHICLES TO CHARGING EQUIPMENT

(71) Applicant: FORD GLOBAL TECHNOLOGIES, LLC, Dearborn, MI (US)

(72) Inventors: Kevin MACKENZIE, Canton, MI (US); Jonathan BARKER, Detroit, MI (US)

(21) Appl. No.: 17/141,543

(22) Filed: Jan. 5, 2021

(51) Int. Cl. B60W 50/16; B60L 53/38; B60L 53/36

(52) U.S. Cl. CPC B60W 50/16; B60W 2556/45; B60L 53/36; B60L 53/38

(57) ABSTRACT

This disclosure relates to systems and methods for providing haptic feedback to a driver when aligning an electrified vehicle to charging equipment in preparation for charging events. Haptic feedback may be provided at the vehicle steering wheel to guide the driver on a correct travel path both laterally and longitudinally relative to the charging equipment. In some embodiments, the haptic feedback is provided at the steering wheel in the form of distinguishable pulsing patterns that alert the driver how the travel path should change for properly aligning the vehicle to the charging equipment. In other embodiments, the haptic feedback is provided in the form of tactile cues, such as making it more difficult for the driver to rotate the steering wheel in a direction that would render the vehicle less aligned to the charging equipment.

### TECHNICAL FIELD

This disclosure relates generally to electrified vehicles, and more particularly to systems and methods for providing haptic feedback when aligning the electrified vehicle to charging equipment.

### BACKGROUND

Electrified vehicles differ from conventional motor vehicles because they are selectively driven by one or more traction battery pack powered electric machines. The electric machines can propel the electrified vehicles instead of, or in combination with, an internal combustion engine. Some electrified vehicles, such as plug-in hybrid electric vehicles (PHEVs) and battery electric vehicles (BEVs), include charging interfaces for wirelessly charging the traction battery pack. The vehicle must be positioned in close proximity relative to charging equipment for achieving maximum wireless power transfer and efficiency.

### SUMMARY

An electrified vehicle according to an exemplary aspect of the present disclosure includes, among other things, a steering wheel, a charging system, and a control module configured to command a first type of haptic feedback at the steering wheel for guiding a lateral charging alignment of a component of the charging system and further configured to command a second type of haptic feedback at the steering wheel for guiding a longitudinal charging alignment of the component.

In a further non-limiting embodiment of the foregoing electrified vehicle, a traction battery pack is configured to receive power from the charging system.

In a further non-limiting embodiment of either of the foregoing electrified vehicles, the lateral charging alignment and the longitudinal charging alignment refer to alignments of the component relative to a charging equipment.

In a further non-limiting embodiment of any of the foregoing electrified vehicles, the component is a vehicle receiver module mounted on the electrified vehicle and the charging equipment includes a ground transmitter module.

In a further non-limiting embodiment of any of the foregoing electrified vehicles, the first type of haptic feedback includes a clockwise pulsing pattern that can be felt as a vibration in the steering wheel.

In a further non-limiting embodiment of any of the foregoing electrified vehicles, the first type of haptic feedback includes a counterclockwise pulsing pattern that can be felt as a vibration in the steering wheel.

In a further non-limiting embodiment of any of the foregoing electrified vehicles, the second type of haptic feedback includes an alternating clockwise and counterclockwise pulsing pattern that can be felt as a vibration in the steering wheel.

In a further non-limiting embodiment of any of the foregoing electrified vehicles, the first type of haptic feedback includes a tactile cue that simulates that the steering wheel is more difficult to rotate in either a first direction or a second direction.

In a further non-limiting embodiment of any of the foregoing electrified vehicles, the steering wheel is part of a steering system that includes a steering shaft, a steering rack, and an electric motor.

In a further non-limiting embodiment of any of the foregoing electrified vehicles, the control module is configured to control the electric motor for applying a varying torque to the steering shaft or the steering rack in order to induce the first type of haptic feedback or the second type of haptic feedback at the steering wheel.

In a further non-limiting embodiment of any of the foregoing electrified vehicles, the control module includes a pulse width modulation (PWM) circuit adapted for controlling the varying torque of the electric motor.

In a further non-limiting embodiment of any of the foregoing electrified vehicles, an alignment system is configured to provide vehicle position information to the control module.

In a further non-limiting embodiment of any of the foregoing electrified vehicles, the alignment system includes at least one wireless device and at least one sensor.

In a further non-limiting embodiment of any of the foregoing electrified vehicles, the control module is configured to correlate an intensity of a pulsing pattern associated with the first type of haptic feedback to an amount of rotation of the steering wheel necessary for achieving the lateral charging alignment.

A method according to another exemplary aspect of the present disclosure includes, among other things, providing a first type of haptic feedback at a steering wheel to guide a driver of an electrified vehicle toward a lateral alignment of the electrified vehicle relative to a charging equipment, and providing a second type of haptic feedback at the steering wheel to guide the driver toward a longitudinal alignment of the electrified vehicle relative to the charging equipment.

In a further non-limiting embodiment of the foregoing method, the first type of haptic feedback instructs the driver to rotate the steering wheel in either a clockwise direction or a counterclockwise direction for achieving the lateral alignment.

In a further non-limiting embodiment of either of the foregoing methods, the second type of haptic feedback instructs the driver to stop further travel in a longitudinal direction for achieving the longitudinal alignment.

In a further non-limiting embodiment of any of the foregoing methods, the method includes altering an intensity of a pulsing pattern associated with the first type of haptic feedback based an amount of rotation of the steering wheel necessary for achieving the lateral alignment.

In a further non-limiting embodiment of any of the foregoing methods, the first type of haptic feedback includes a first pulsing pattern and the second type of haptic feedback includes a second pulsing pattern that is different from the first pulsing pattern.

In a further non-limiting embodiment of any of the foregoing methods, the first pulsing pattern includes a clockwise or counterclockwise pulsing pattern and the second pulsing pattern includes an alternating clockwise and counterclockwise pulsing pattern.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a perspective view of an electrified vehicle equipped with a charging system.

FIG. 2 is a block diagram of a vehicle system of the electrified vehicle of FIG. 1.

FIG. 3 schematically illustrates providing a first type of haptic feedback to a driver when aligning an electrified vehicle to charging equipment.

FIG. 4 schematically illustrates providing a second type of haptic feedback the driver when aligning the electrified vehicle to charging equipment.

FIG. 5 schematically illustrates providing a third type of haptic feedback to the driver when aligning an electrified vehicle to charging equipment.

FIG. 6 schematically illustrates providing a fourth type of haptic feedback to the driver when aligning an electrified vehicle to charging equipment.

FIG. 7 schematically illustrates providing a fifth type of haptic feedback to the driver when aligning an electrified vehicle to charging equipment.

### DETAILED DESCRIPTION

This disclosure relates to systems and methods for providing haptic feedback to a driver when aligning an electrified vehicle to charging equipment in preparation for charging events. Haptic feedback may be provided at the vehicle steering wheel to guide the driver on a correct travel path both laterally and longitudinally relative to the charging equipment. In some embodiments, the haptic feedback is provided at the steering wheel in the form of distinguishable pulsing patterns that alert the driver how the travel path should change for properly aligning the vehicle to the charging equipment. In other embodiments, the haptic feedback is provided in the form of tactile cues, such as making it more difficult for the driver to rotate the steering wheel in a direction that would render the vehicle less aligned to the charging equipment. These and other features of this disclosure are discussed in greater detail in the following paragraphs of this detailed description.

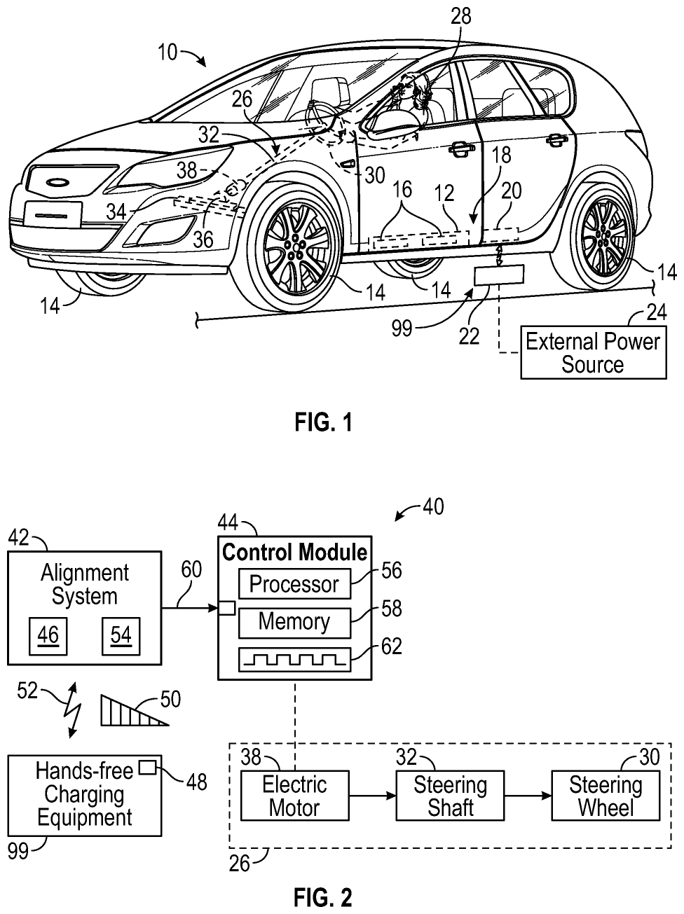

FIG. 1 schematically illustrates an exemplary electrified vehicle 10 that includes a traction battery pack 12. The electrified vehicle 10 may include any electrified powertrain capable of applying a torque from an electric machine (e.g., an electric motor) for driving drive wheels 14 of the electrified vehicle 10. In an embodiment, the electrified vehicle 10 is a plug-in hybrid electric vehicle (PHEV). In another embodiment, the electrified vehicle is a battery electric vehicle (BEV). Therefore, the powertrain may electrically propel the drive wheels 14 either with or without the assistance of an internal combustion engine.

The electrified vehicle 10 of FIG. 1 is schematically illustrated as a car. However, the teachings of this disclosure may be applicable to any type of vehicle, including but not limited to, cars, trucks, vans, sport utility vehicles (SUVs), etc. Moreover, although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component.

Although shown schematically, the traction battery pack 12 may be a high voltage traction battery pack that includes a plurality of battery arrays 16 (i.e., battery assemblies or groupings of battery cells) capable of outputting electrical power to one or more electric machines of the electrified vehicle 10. Other types of energy storage devices and/or output devices may also be used to electrically power the electrified vehicle 10.

From time to time, charging the energy storage devices of the traction battery pack 12 may be required or desirable. The electrified vehicle 10 may therefore be equipped with a charging system 18 for wirelessly charging the energy storage devices (e.g., battery cells) of the traction battery pack 12. The charging system 18 may be a hands-free inductive charging system or a hands-free conductive charging system, for example. However, other charging systems for wirelessly charging the traction battery pack 18 are also contemplated within the scope of this disclosure.

The charging system 18 may include a vehicle receiver module 20 mounted on the electrified vehicle 10. The vehicle receiver module 20 is configured to wirelessly receive power from a ground transmitter module 22 of a charging equipment 99 for wirelessly charging the traction battery pack 12 from an external power source 24 (e.g., utility grid power). Although not shown, the electrified vehicle 10 could be equipped with one or more additional charging interfaces.

The electrified vehicle 10 additionally includes a steering system 26 through which a driver 28 may steer the electrified vehicle 10. In an embodiment, the steering system 26 is part of an electric power assisted system (EPAS). However, other types of steering systems are also contemplated within the scope of this disclosure.

The steering system 26 may include a steering wheel 30, a steering shaft 32 connected to the steering wheel 30, and a steering rack 34 that is operably connected to the front drive wheels 14. A pinion gear 36 of the steering shaft 32 may operably engage the steering rack 34 in order to move the steering rack 34 in response to rotating the steering wheel 30, thereby transferring motion of the steering wheel 30 to the drive wheels 14 for steering the electrified vehicle 10.

The steering system 26 may additionally include an electric motor 38 that is operably connected to either the steering shaft 32 or the steering rack 34. The electric motor 38 may be selectively controlled to apply a power boost to the steering system 26, thereby assisting the driver 28 in turning the steering wheel 30 in a desired direction. For example, an output shaft of the electric motor 38 may turn in the same direction as the steering wheel 30 in order to assist the turning motion of the steering wheel 30 as part of an EPAS.

The electrified vehicle 10 must be properly aligned to the charging equipment 99 for achieving maximum wireless power transfer and efficiency during wireless charging events. For example, it is necessary for the vehicle receiver module 20 to be properly aligned in the lateral and longitudinal directions relative to the ground transmitter module 22 for achieving the maximum power transfer. This disclosure therefore describes systems and methods for providing haptic feedback to the driver 28 when aligning the electrified vehicle 10 to the charging equipment 99 for charging the traction battery pack 12.

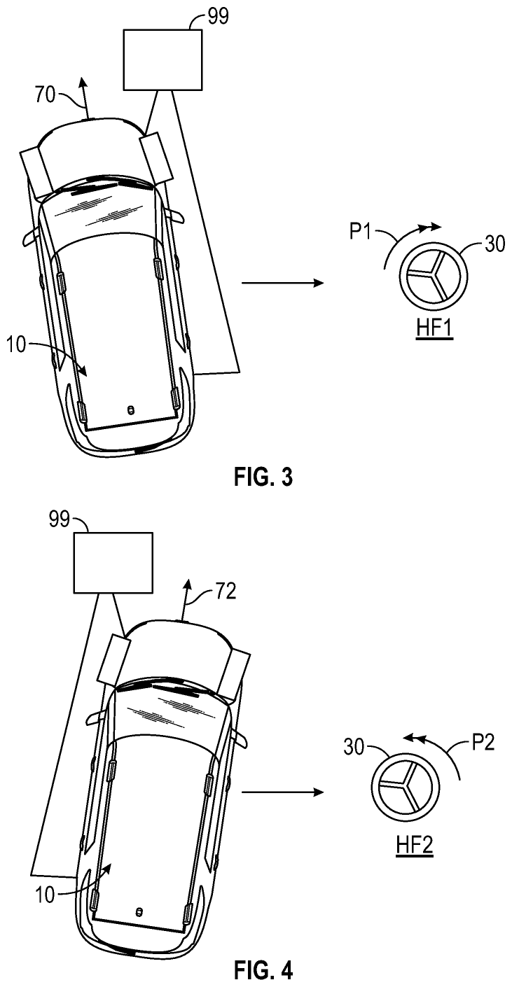

FIG. 2 is a highly schematic depiction of an exemplary vehicle system 40 that can be employed within the electrified vehicle 10 of FIG. 1 for achieving proper alignment relative to the charging equipment 99 (e.g., a ground transmitter module). For example, the vehicle system 40 may periodically command that haptic feedback be provided at the steering wheel 30 of the steering system 26 in various patterns or forms for indicating to the driver 28 whether or not they are on the correct travel path both laterally and longitudinally relative to the charging equipment 99. As discussed in greater detail below, different types of haptic feedback can be provided at the steering wheel 30 for guiding the driver 28 both laterally and longitudinally.

In an embodiment, the vehicle system 40 includes an alignment system 42 and a control module 44. The alignment system 42 is configured to provide vehicle position information to the control module 44 for enabling the control module 44 to determine the vehicle travel path and whether the vehicle travel path needs to be altered for properly aligning the electrified vehicle 10 relative to the charging equipment 99.

The alignment system 42 may include one or more wireless devices 46 that facilitate the detection of and communication with nearby devices, such as the charging equipment 99 or a charging station associated with the charging equipment 99. In an embodiment, the wireless device 46 is a Bluetooth Low Energy (BLE) transceiver configured to receive and/or emit low energy Bluetooth signals as a way to detect and communicate with the charging equipment 99. However, other types of wireless devices are also contemplated within the scope of this disclosure.

The charging equipment 99 (or associated charging station) may also include one or more wireless devices 48 (e.g., another BLE transceiver) configured to communicate with the wireless device 46 of the alignment system 42 over a wireless connection 50. The wireless connection 50 may be a BLE connection, a Wi-Fi connection, a near field communication (NFC) connection, a wireless network connection, a radio-frequency connection, or any other type of wireless connection. The wireless device 46 of the alignment system 42 may periodically (e.g., about every half-second or any other time interval) broadcast wireless signals 52 that may be received by the wireless device 48 of the charging equipment 99. Based on the information received from the alignment system 42, the control module 44 can determine the position of the electrified vehicle 10, and more particularly the vehicle receiver module 20 of the electrified vehicle 10, relative to the charging equipment 99. The control module 44 can further determine how the travel path of the electrified vehicle 10 needs to be altered in order to properly align the electrified vehicle 10 to the charging equipment 99.

The alignment system 42 may additionally include one or more sensors 54 adapted for monitoring one or more aspects of the steering system 26. In an embodiment, the sensors 54 include a steering wheel angle sensor for estimating the angle of the steering wheel 30. In another embodiment, the sensors 54 include a torque sensor for estimating the amount of torque being applied to the steering wheel 30 or the steering shaft 32. Other sensors, such as vehicle dynamics sensors (speed, acceleration, wheel spin/slip, etc.) could alternatively or additionally be provided as part of the alignment system 42. Information from the one or more sensors 54 may be sent to the control module 44 for assisting in the determination of whether or not the vehicle travel path needs to be altered in some way for properly aligning the electrified vehicle 10 relative to the charging equipment 99.

The control module 44 may be part of an overall vehicle control system or could be a separate control system that communicates with the vehicle control system. In an embodiment, the control module 44, the steering system 26, and the alignment system 42 are part of the same EPAS.

The control module 44 may include a processing unit 56 and non-transitory memory 58 for executing the various control strategies and modes of the vehicle system 40. The control module 44 may be configured to receive various inputs, analyze these inputs, and then command various operations of the vehicle system 40. The processing unit 56 can be a custom made or commercially available processor, a central processing unit (CPU), or generally any device for executing software instructions. The memory 58 can include any one or combination of volatile memory elements and/or nonvolatile memory elements.

In an embodiment, based at least on an input signal 60 received from the alignment system 42, the control module 44 may determine whether to provide haptic feedback at the steering wheel 30 in order to alert the driver 28 that they are on an incorrect travel path either laterally or longitudinally relative to the charging equipment 99. Different types of haptic feedback may be provided for indicating lateral and longitudinal misalignment. The haptic feedback may be provided at the steering wheel 30 by commanding the electric motor 38 to apply a varying torque to the steering shaft 32 (and/or the steering rack 34). In an embodiment, the varying torque applied by the electric motor 38 is felt by the driver 28 in the form of a vibration in the steering wheel 30. In another embodiment, the varying torque is felt by the driver 28 in the form of a tactile cue that simulates that the steering wheel 30 is more difficult to turn in one direction versus another direction. The haptic feedback provided to the driver 28 can be tailored to indicate to the driver 28 that the vehicle travel path needs to be altered in a specific way for proper alignment to the charging equipment 99.

The control module 44 may additionally include a pulse width modulation (PWM) circuit 62 for achieving a desired level of haptic feedback at the steering wheel 30. For example, the PWM circuit 62 may be controlled to vary the amount of torque applied by the electric motor 38 to the steering shaft 32 based on the current position, as indicated by the alignment system 42, of the electrified vehicle 10 relative to the charging equipment 99. The electric motor 38 can be controlled using various modulation patterns, duty cycles, frequencies, etc. for achieving the desired level of haptic feedback.

FIGS. 3-7, with continued reference to FIGS. 1-2, schematically illustrate various forms of haptic feedback that can be provided by the vehicle system 40 to the steering wheel 30 when aligning the electrified vehicle 10 to the charging equipment 99.

A first type of haptic feedback HF1 is schematically illustrated in FIG. 3. In the illustrated example, the electrified vehicle 10 is moving toward the charging equipment 99, but a travel path 70 of the electrified vehicle 10 is laterally offset to the left-hand side of the charging equipment 99. The first haptic feedback HF1 may therefore be commanded by the control module 44 (e.g., by commanding to electric motor 38 to apply a varying torque to the steering shaft 32) for alerting the driver 28 that the electrified vehicle 10 needs to be turned to the right (e.g., by rotating the steering wheel 30 to the right or clockwise) for achieving proper alignment with the charging equipment 99. In an embodiment, the first haptic feedback HF1 is provided in the form of a clockwise pulsing pattern P1 that is felt as vibrations in the steering wheel 30.

Another type of haptic feedback HF2 is schematically illustrated in FIG. 4. In the illustrated example, the electrified vehicle 10 is moving toward charging equipment 99, but a travel path 72 of the electrified vehicle 10 is laterally offset to the right-hand side of the charging equipment 99. The second haptic feedback HF2 may therefore be commanded by the control module 44 (e.g., by commanding to electric motor 38 to apply the varying torque to the steering shaft 32) for alerting the driver 28 that the electrified vehicle 10 needs to be turned to the left (e.g., by rotating the steering wheel 30 to the left or counterclockwise) for achieving proper alignment with the charging equipment 99. In an embodiment, the second type of haptic feedback HF2 is provided in the form of a counterclockwise pulsing pattern P2 that is felt as vibrations in the steering wheel 30.

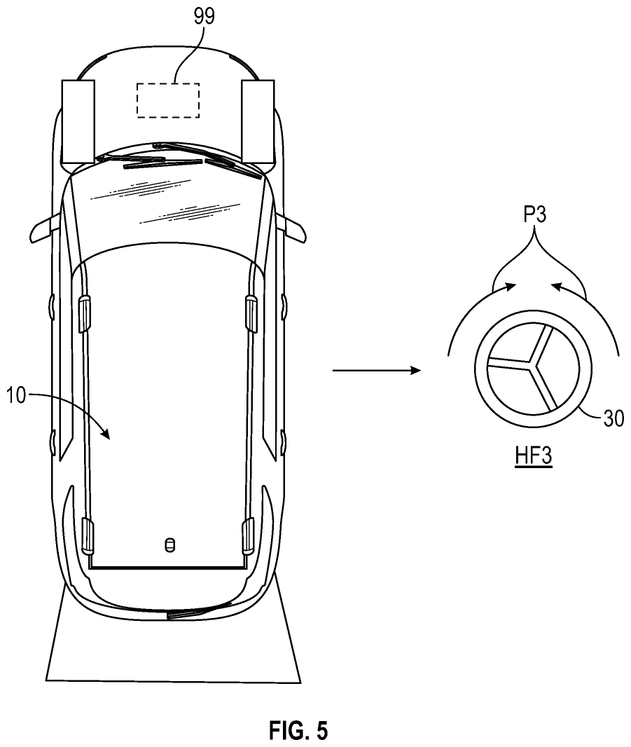

Another type of haptic feedback HF3 is schematically illustrated in FIG. 5. In the illustrated example, the electrified vehicle 10 has been moved into a correct longitudinal position relative to the charging equipment 99. The haptic feedback HF3 may therefore be commanded by the control module 44 for alerting the driver 28 that the electrified vehicle 10 needs to stop and avoid further forward movement for maintaining proper alignment with the charging equipment 99. In an embodiment, the type of haptic feedback HF3 is in the form of an alternating clockwise and counterclockwise pulsing pattern P3 that is felt as vibrations in the steering wheel 30. Thus, a different pulsing pattern can be applied for indicating longitudinal alignment as compared to lateral alignment.

The intensity of the pulsing patterns P1, P2, and P3, and thus the intensity of the corresponding vibrations felt within the steering wheel 30, may be correlated to an amount of steering wheel 30 rotation that is necessary for achieving proper alignment relative to the charging equipment 99. For example, the control module 44 may be programmed to automatically increase the intensity of the applied pulsing pattern as the electrified vehicle 10 moves further away from being in proper alignment relative to the charging equipment 99, and the intensity of the applied pulsing pattern may be automatically decreased as the electrified vehicle 10 moves closer to being in proper alignment relative to the charging equipment 99.

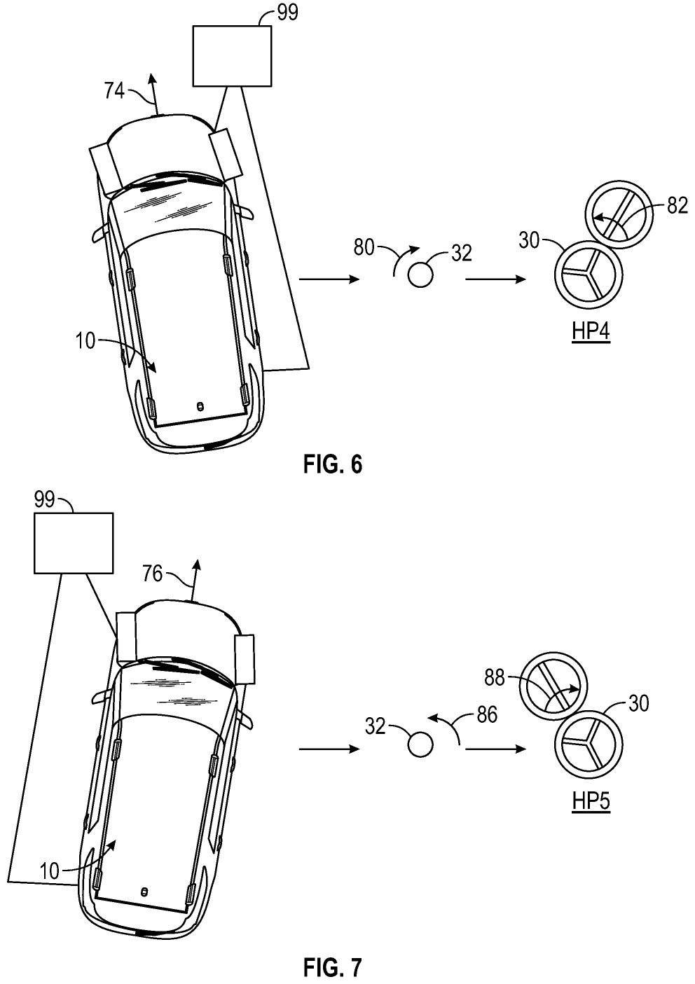

FIG. 6 illustrates another type of haptic feedback HP4 that can be provided by the vehicle system 40 for alerting the driver 28 that the vehicle travel path needs to be altered for achieving proper alignment to the charging equipment 99. In the illustrated example, the electrified vehicle 10 is moving toward the charging equipment 99, but the current travel path 74 of the electrified vehicle 10 is laterally offset to the left of the charging equipment 99. The haptic feedback HP4 may therefore be commanded by the control module 44 for alerting the driver 28 that the electrified vehicle 10 needs to be turned to the right (e.g., by rotating the steering wheel 30 to the right) for achieving proper alignment with the charging equipment 99. In this embodiment, the haptic feedback HF4 is provided by applying a counteracting torque 80 to the steering shaft 32 (or the steering rack 34). The counteracting torque 80 is applied in an opposite direction from the direction 82 of undesired rotation of the steering wall 30. The counteracting torque 80 thus makes it more difficult for the driver 28 to rotate the steering wheel 30 further in the lateral left direction and therefore tacitly guides the driver 28 to properly position the electrified vehicle 10 relative to the charging equipment 99.

FIG. 7 illustrates yet another type of haptic feedback HP5 that can be provided by the vehicle system 40 for alerting the driver 28 that the vehicle path needs to be altered in some way for achieving proper alignment to the charging equipment 99. In the illustrated situation, the electrified vehicle 10 is moving toward the charging equipment 99 but the current travel path 76 of the electrified vehicle 10 is laterally to the right of the charging equipment 99. The haptic feedback HP5 may therefore be commanded by the control module 44 for alerting the driver 28 that the electrified vehicle 10 needs to be turned to the left (e.g., by rotating the steering wheel 30 to the left) for achieving proper alignment with the charging equipment 99. In this embodiment, the haptic feedback HF5 is provided by applying a counteracting torque 86 to the steering shaft 32. The counteracting torque 86 is applied in an opposite direction from the direction 88 of undesired rotation of the steering wall 30. The counteracting torque 86 thus makes it more difficult for the driver 28 to rotate the steering wheel 30 further in the lateral right direction and therefore tacitly guides the driver 28 to properly position the electrified vehicle 10 relative to the charging equipment 99.

The types of haptic feedback schematically illustrated in FIGS. 3-7 are intended to be non-limiting examples. The control module 44 may be configured to control the electric motor 38 for providing various types of haptic feedback at the steering wheel 30. The haptic feedback may take various forms including but not limited to various pulsing patterns, intensities, tactile cues, etc.

The vehicle systems and methods of this disclosure are designed to improve vehicle-to-charging equipment alignment and customer satisfaction by providing haptic feedback through a steering wheel during charging events. The haptic feedback is designed to guide the driver to improve vehicle-to-charging equipment alignment without the need for the driver to take his or her eyes off the road and surroundings.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. An electrified vehicle, comprising:
a steering wheel;
a charging system; and
a control module configured to command a first type of haptic feedback at the steering wheel for guiding a lateral charging alignment of a component of the charging system and further configured to command a second type of haptic feedback at the steering wheel for guiding a longitudinal charging alignment of the component.

2. The electrified vehicle as recited in claim 1, comprising a traction battery pack configured to receive power from the charging system.

3. The electrified vehicle as recited in claim 1, wherein the lateral charging alignment and the longitudinal charging alignment refer to alignments of the component relative to a charging equipment.

4. The electrified vehicle as recited in claim 3, wherein the component is a vehicle receiver module mounted on the electrified vehicle and the charging equipment includes a ground transmitter module.

5. The electrified vehicle as recited in claim 1, wherein the first type of haptic feedback includes a clockwise pulsing pattern that can be felt as a vibration in the steering wheel.

6. The electrified vehicle as recited in claim 1, wherein the first type of haptic feedback includes a counterclockwise pulsing pattern that can be felt as a vibration in the steering wheel.

7. The electrified vehicle as recited in claim 1, wherein the second type of haptic feedback includes an alternating clockwise and counterclockwise pulsing pattern that can be felt as a vibration in the steering wheel.

8. The electrified vehicle as recited in claim 1, wherein the first type of haptic feedback includes a tactile cue that simulates that the steering wheel is more difficult to rotate in either a first direction or a second direction.

9. The electrified vehicle as recited in claim 1, wherein the steering wheel is part of a steering system that includes a steering shaft, a steering rack, and an electric motor.

10. The electrified vehicle as recited in claim 9, wherein the control module is configured to control the electric motor for applying a varying torque to the steering shaft or the steering rack in order to induce the first type of haptic feedback or the second type of haptic feedback at the steering wheel.

11. The electrified vehicle as recited in claim 10, wherein the control module includes a pulse width modulation (PWM) circuit adapted for controlling the varying torque of the electric motor.

12. The electrified vehicle as recited in claim 1, comprising an alignment system configured to provide vehicle position information to the control module.

13. The electrified vehicle as recited in claim 12, wherein the alignment system includes at least one wireless device and at least one sensor.

14. The electrified vehicle as recited in claim 1, wherein the control module is configured to correlate an intensity of a pulsing pattern associated with the first type of haptic feedback to an amount of rotation of the steering wheel necessary for achieving the lateral charging alignment.

15. A method, comprising:
providing a first type of haptic feedback at a steering wheel to guide a driver of an electrified vehicle toward a lateral alignment of the electrified vehicle relative to a charging equipment; and
providing a second type of haptic feedback at the steering wheel to guide the driver toward a longitudinal alignment of the electrified vehicle relative to the charging equipment.

16. The method as recited in claim 15, wherein the first type of haptic feedback instructs the driver to rotate the steering wheel in either a clockwise direction or a counterclockwise direction for achieving the lateral alignment.

17. The method as recited in claim 15, wherein the second type of haptic feedback instructs the driver to stop further travel in a longitudinal direction for achieving the longitudinal alignment.

18. The method as recited in claim 15, comprising:
altering an intensity of a pulsing pattern associated with the first type of haptic feedback based an amount of rotation of the steering wheel necessary for achieving the lateral alignment.

19. The method as recited in claim 15, wherein the first type of haptic feedback includes a first pulsing pattern and the second type of haptic feedback includes a second pulsing pattern that is different from the first pulsing pattern.

20. The method as recited in claim 19, wherein the first pulsing pattern includes a clockwise or counterclockwise pulsing pattern and the second pulsing pattern includes an alternating clockwise and counterclockwise pulsing pattern.
